(19) United States
(12) Patent Application Publication
(10) Pub. No.: US 2025/0203512 A1
(43) Pub. Date: Jun. 19, 2025

(54) POWER SAVING OPERATIONS FOR ACCESS POINTS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 18/970,727

(22) Filed: Dec. 5, 2024

Related U.S. Application Data
(60) Provisional application No. 63/611,597, filed on Dec. 18, 2023.

(51) Int. Cl. H04W 52/02

(52) U.S. Cl. CPC H04W 52/0216; H04W 52/0219

(57) ABSTRACT

An access point (AP) in a wireless network, comprising a memory and a processor coupled to the memory, the processor configured to: establish a power saving schedule in a basic service set (BSS), wherein the power saving schedule includes one or more unavailable periods during which the AP is not available for frame exchange; transmit, to one or more stations STAs, a first frame that includes power saving schedule information; exchange, with the one or more STAs, one or more frames during a period that does not belong to the power saving schedule; and transition to a power saving mode during the one or more unavailable periods based on the power saving schedule.

### CROSS-REFERENCE TO RELATED APPLICATION(S)

This application claims the benefit of priority from U.S. Provisional Application No. 63/611,597, entitled “POWER SAVING OPERATION FOR ACCESS POINTS” filed Dec. 18, 2023, which is incorporated herein by reference in its entirety.

### TECHNICAL FIELD

This disclosure relates generally to a wireless communication system, and more particularly to, for example, but not limited to, power saving operations for access points (APs) in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides an access point (AP) in a wireless network, comprising a memory and a processor coupled to the memory. The processor is configured to establish a power saving schedule in a basic service set (BSS), wherein the power saving schedule includes one or more unavailable periods during which the AP is not available for frame exchange. The processor is configured to transmit, to one or more stations (STAs), a first frame that includes power saving schedule information. The processor is configured to exchange, with the one or more STAs, one or more frames during a period that does not belong to the power saving schedule. The processor is configured to transition to a power saving mode during the one or more unavailable periods based on the power saving schedule.

In some embodiments, the AP abstains from transmitting to or receiving any frames from the one or more STAs during the one or more unavailable periods.

In some embodiments, the power saving schedule information includes a first time indicating when an unavailable period starts and a second time indicating a duration of the unavailable period.

In some embodiments, the first frame is a beacon frame; and the power saving schedule information includes a beacon counter indicating after which target beacon transmission time (TBTT) the power saving schedule takes effect or is suspended.

In some embodiments, the power saving schedule information includes information indicating an unavailable period interval that represents a time between a first start time of a first unavailable period and a second start time of a second unavailable period.

In some embodiments, the first frame is an individually addressed frame that is transmitted to each of the one or more STAs.

In some embodiments, the processor is further configured to transmit, to the one or more STAs, a second frame indicating whether the AP supports the power saving schedule.

One aspect of the present disclosure provides a station (STA) in a wireless network, comprising a memory and a processor coupled to the memory. The processor is configured to: receive, from an access point (AP), a first frame that includes power saving schedule information, wherein the power saving schedule includes one or more unavailable periods during which the AP is not available for frame exchange. The processor is configured to exchange, with the AP, one or more frames during a period that does not belong to the power saving schedule. The processor is configured to transition to a power saving mode during the one or more unavailable periods based on the power saving schedule.

In some embodiments, the STA abstains from transmitting to or receiving any frames from the AP during the one or more unavailable periods.

In some embodiments, the power saving schedule information includes a first time indicating when an unavailable period starts and a second time indicating a duration of the unavailable period.

In some embodiments, the first frame is a beacon frame; and the power saving schedule information includes a beacon counter indicating after which target beacon transmission time (TBTT) the power saving schedule takes effect or is suspended.

In some embodiments, the power saving schedule information includes information indicating an unavailable period interval that represents a time between a first start time of a first unavailable period and a second start time of a second unavailable period.

In some embodiments, the first frame is an individually addressed frame that is received by the STA.

In some embodiments, the processor is further configured to receive, from the AP, a second frame indicating whether the AP supports the power saving schedule.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example network in accordance with an embodiment.

FIG. 5 illustrates unavailability periods of an AP in accordance with an embodiment.

FIG. 6 illustrates advertisement of an AP's unavailability schedule information in accordance with an embodiment.

FIG. 7 illustrates an unavailability schedule start indication using Unavailability Schedule Start Count information in accordance with an embodiment.

FIG. 8 illustrates an unavailability schedule suspension indication using Unavailability Schedule End Count information in accordance with an embodiment.

FIG. 9 illustrates an unavailability schedule indication using individually addressed frame in accordance with an embodiment.

FIG. 10 illustrates an unavailability schedule operation with Multi-Link Operation (MLO) in accordance with an embodiment.

FIG. 11 illustrates a flow chart of an example process by an AP for the AP's unavailability schedule operation in accordance with an embodiment.

FIG. 12 illustrates a flow chart of an example process by an STA for an AP's unavailability schedule operation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

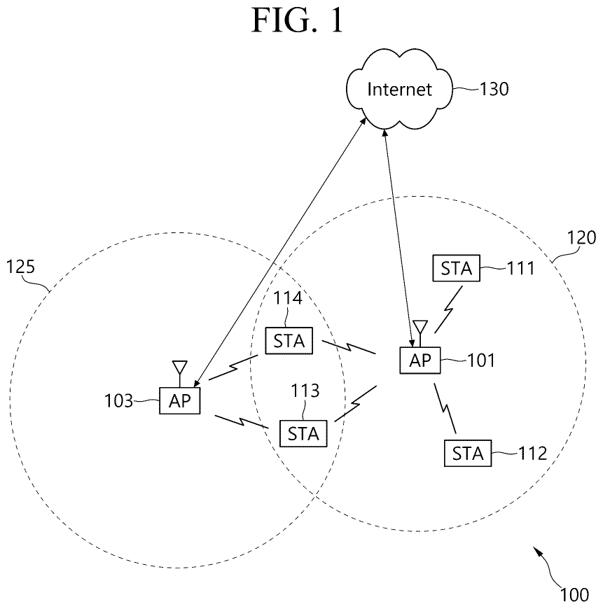

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

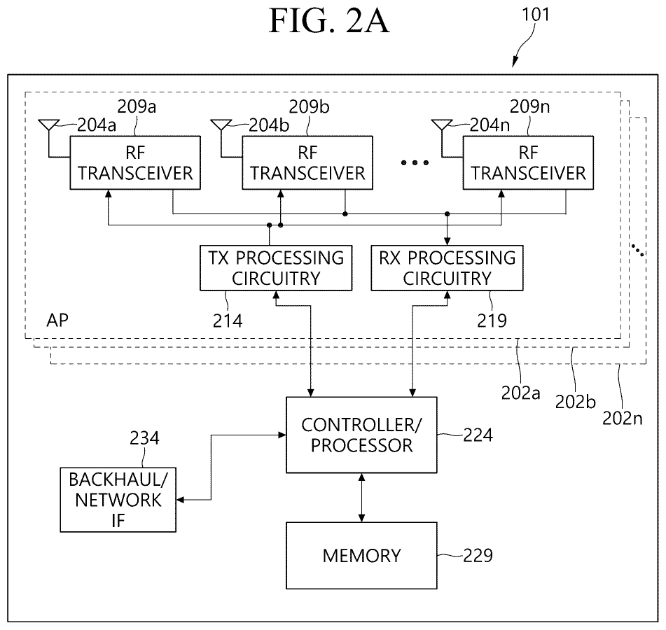

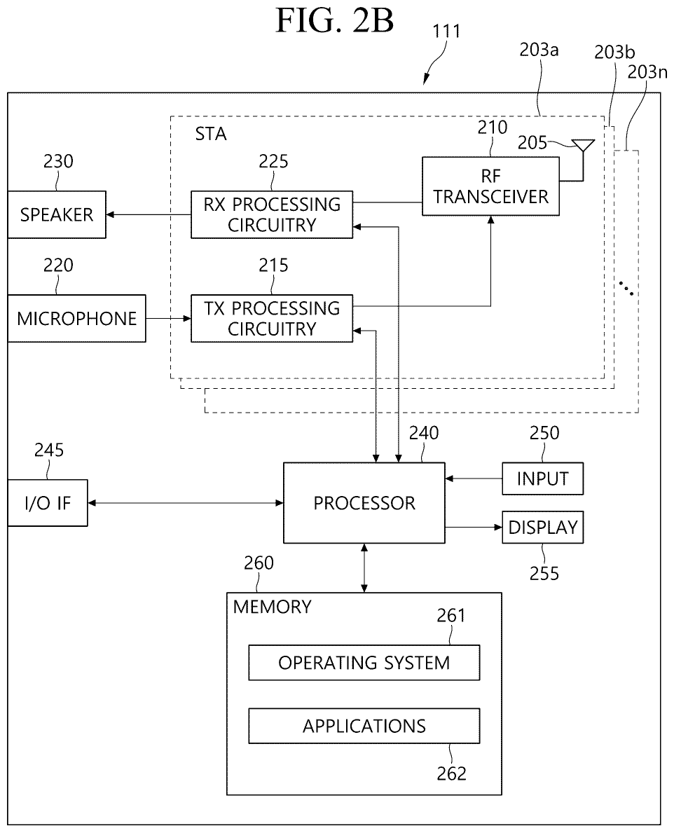

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

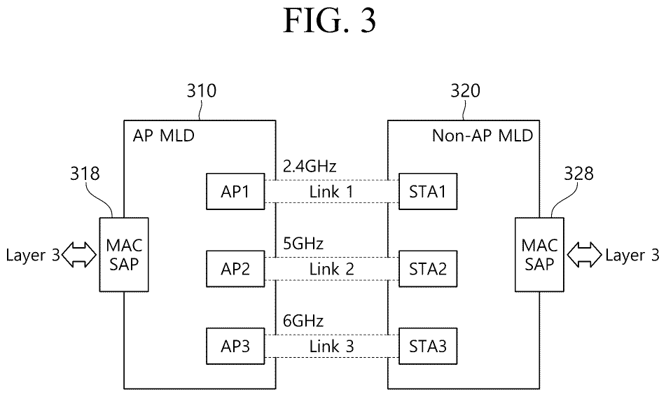

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

In a typical WLAN system, multiple STAs can be associated with an access point (AP). The associated non-AP STAs can transmit frames to the AP in the uplink (UL). Similarly, the AP can transmit frames to one or more of the associated STAs in the downlink (DL). For longer battery life, the non-AP STAs often adopt power-saving strategies. When a non-AP STA goes to power saving mode (e.g., sleep mode or doze state), it may indicate this to the associated AP. Accordingly, the AP may refrain from transmitting any frames to that STA in the downlink or triggering that STA for uplink transmission during the time when the non-AP STA is not in an active mode (e.g., awake state) of operation.

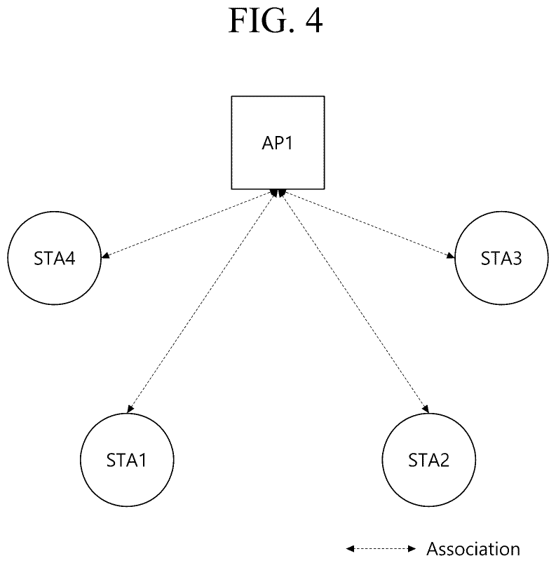

FIG. 4 illustrates a typical WLAN system where multiple non-AP STAs are associated with the AP. In particular, FIG. 4 illustrates an AP associated with STA1, STA2, STA3, and STA4.

APs have generally been expected to be available at all times so that an STA can transmit frames to the AP at any time. However, an AP may benefit from improved power-consumption. Accordingly, embodiment in accordance with this disclosure provide for an AP that may use various power-consumption techniques that help reduce the energy-consumption footprint of the wireless network. Accordingly, embodiment in accordance with this disclosure may allow the AP to establish a power saving schedule in the basic service set (BSS).

In some embodiments, an AP can establish an unavailability schedule for the AP in the AP's basic service set (BSS). The unavailability schedule may indicate a set of periods of time during which the AP is not available (e.g., by transitioning to a power saving mode) for a frame exchange with any of its associated non-AP STAs or any other STAs. The unavailability schedule may include a set of parameters that describe a set of unavailability periods during which the AP would be unavailable.

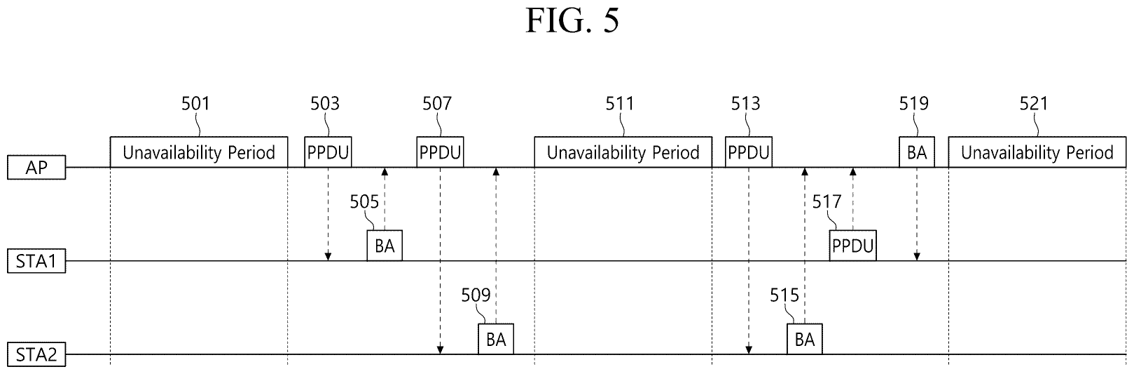

FIG. 5 illustrates unavailability periods of an AP unavailability schedule in accordance with an embodiment. In some embodiments, the unavailability schedule related information can be carried in a Beacon or Probe Response frame and can be advertised by the AP in its BSS. Such unavailability information may indicate a set of unavailability periods as well as an unavailability interval. In particular, FIG. 5 illustrates communication between an AP, STA1, and STA2. As illustrated, the AP has several unavailability periods during which the AP may be in a power saving mode (e.g., doze state), and during which it may not receive or transmit any frames. The illustrated unavailability periods include unavailability periods 501, 511 and 521. Between these periods, the AP can be in an active mode and may communicate frames with the associated STAs. As illustrated in this example, after unavailability period 501, AP transmits a physical layer protocol data unit (PPDU) 503 to STA1 and STA1 transmits a block acknowledgement (BA) 505 to AP. Likewise, AP transmits PPDU 507 to STA2 and STA2 transmits BA 509 to AP. After unavailability period 511, AP transmits a PPDU 513 to STA2 and STA2 transmits a BA 515 to AP. STA1 transmits PPDU 517 to AP and AP transmits BA 519 to STA1. After which there is unavailability period 521 during which the AP may transition to the power save mode. Accordingly, no frames are exchanged among the AP, STA1, and STA2 during the various unavailability periods 501, 511 and 521.

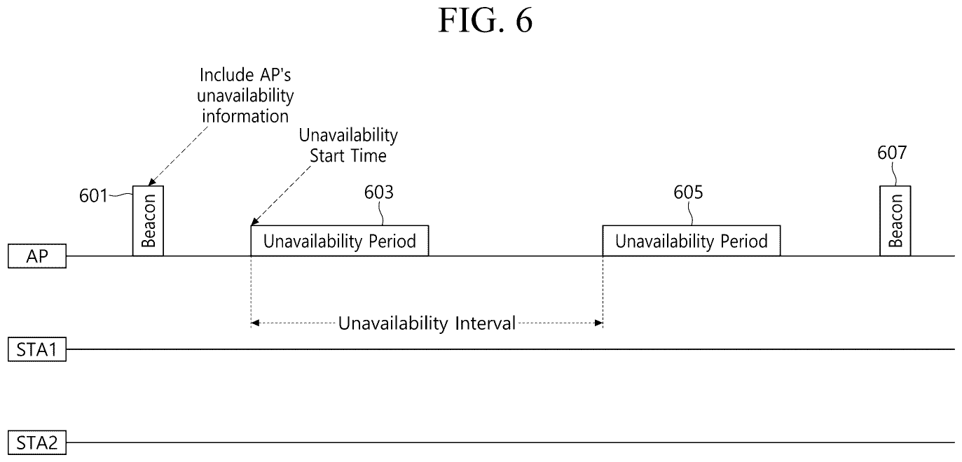

FIG. 6 illustrates advertisement of an AP's unavailability schedule information in accordance with an embodiment. In particular, FIG. 6 illustrates communication between an AP, STA1, and STA2. AP transmits a Beacon frame 601 that includes the AP's unavailability information, which can be received by STA1 and STA2. Accordingly, the unavailability periods include unavailability period 603 with an indicated unavailability start time and unavailability period 605. FIG. 6 also illustrates an unavailability interval 609 from the unavailability start time 603 to the unavailability start time 605. In some embodiments, the unavailability interval 609 indicates a period time between the start of each unavailability period. In some embodiments, the unavailability schedule start time and end time can be indicated during the advertisement phase. For example, a Beacon counter can be used to indicate after which Target Beacon Transmission Time (TBTT) the schedule will take into effect or will be suspended.

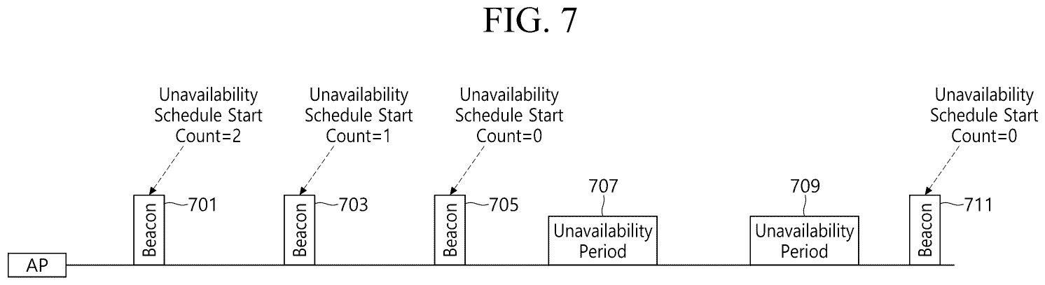

FIG. 7 illustrates an unavailability schedule start indication using Unavailability Schedule Start Count information in accordance with an embodiment. As illustrated, AP transmits a Beacon frame 701 that includes an unavailability schedule start count=2. In some embodiments, the counter may indicate after which TBTT the schedule will take into effect, which in this example is after 2 TBTTs.

At a later time, the AP transmits a Beacon frame 703 that includes an unavailability schedule start count=1, which indicates after one TBTT the schedule will take effect. At a later time, the AP transmits a Beacon frame 705 that includes an unavailability schedule start count=0, which indicates after zero TBTTs the schedule will take into effect. At a later time, as illustrated, the AP becomes unavailable (e.g., transitions to a power saving mode) during the unavailability period 707 and the unavailability period 709. After the unavailability period 709, the AP transmits a beacon frame 711 that includes an unavailability schedule start count=0.

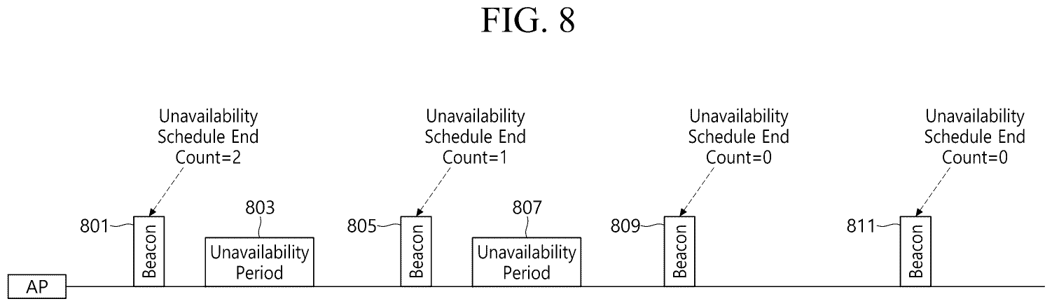

FIG. 8 illustrates an unavailability schedule suspension indication using Unavailability Schedule End Count information in accordance with an embodiment. As illustrated, AP transmits a Beacon frame 801 that includes an unavailability schedule end count=2, which may indicate that after 2 TBTTS, the unavailability schedule will end. At a later time, the AP becomes unavailable in the unavailability period 803. At a later time, the AP transmits a Beacon frame 805 that includes an unavailability schedule end count=1, which indicates that after 1 TBTT, the unavailability schedule will end. At a later time, the AP transitions to the power saving mode in the unavailability period 807. At a later time, the AP transmits a Beacon frame 809 that includes an unavailability schedule end count=0, which indicates after zero TBTTs, the unavailability schedule will end. Accordingly, as illustrated, there is no unavailability period after the Beacon frame 809 as the unavailability schedule has ended. At a later time, the AP transmits a Beacon frame 811 that includes an unavailability schedule end count=0, which indicates that the unavailability schedule has ended.

In some embodiments, an AP may start or end an unavailability schedule with an associated non-AP STA by sending an individually addressed frame to that STA, where the frame can carry information related to the AP's unavailability schedule.

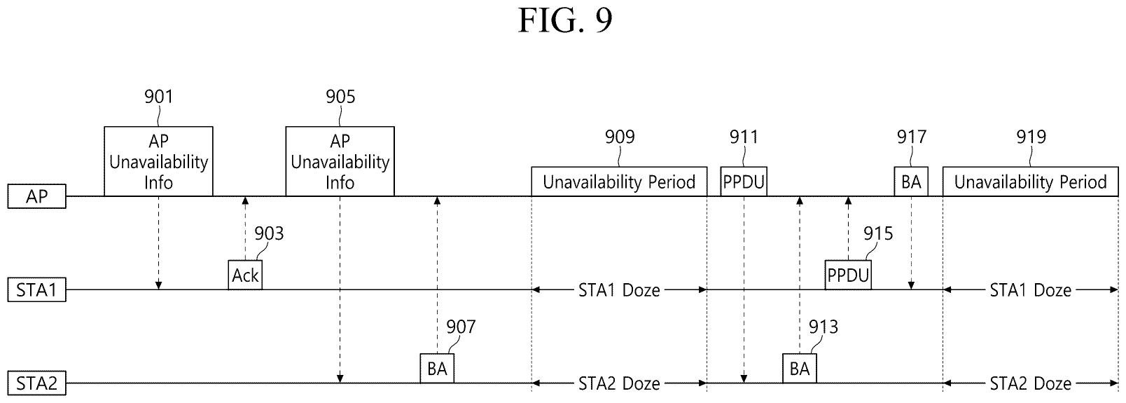

FIG. 9 illustrates an unavailability schedule indication using individually addressed frame in accordance with an embodiment. In particular, FIG. 9 illustrates communication between an AP, STA1, and ST2. The AP transmits to STA1 a frame 901 that includes the AP's unavailability information. STA1 transmits an acknowledgement (Ack) frame 903 to AP. AP transmits to STA2 a frame 905 that includes the AP's unavailability information. STA2 transmits a Block Acknowledgement (BA) 907 to AP. At a later time, AP is unavailable (e.g., in a power save mode) during unavailability period 909. Accordingly, STA1 and STA2 transition to a doze state. As illustrated, no frames are exchanged among the AP, STA1, and STA2 during the unavailability period 909.

At a later time after the unavailability period 909, AP transmits a PPDU 911 to STA2. STA2 transmits a BA to AP. At a later time, STA1 transmits PPDU 915 to AP and AP transmits a BA 917 to STA1. At a later time, AP becomes unavailable (e.g., transitions to power saving mode) during unavailability period 919, during which STA1 and STA2 transition to a doze state. As illustrated, no frames are exchanged among the AP, STA1, and STA2 during the unavailability period 919.

In some embodiments, whether a STA (e.g., AP or non-AP STA) supports an AP's unavailability can be indicated by including a capability bit in the Ultra High Reliability (UHR) or Extremely High Throughput (EHT) Capability Information field. In some embodiment, if the bit is set to 1, it may indicate that the STA supports AP's unavailability schedule; otherwise, the STA does not support AP's unavailability schedule.

In some embodiments, to better support those STAs that don't support AP's unavailability schedule, multi-link operation can be used. For example, an AP MLD may not associate with a STA affiliated with a non-AP MLD on a link if that STA does not support AP's unavailability schedule. The AP MLD may serve the non-AP MLD on other links of the AP MLD.

In some embodiments, an unavailability schedule may be supported at the MLD level, where if an MLD supports an unavailability schedule, than all STAs affiliated with the MLD support the unavailability schedule. Likewise, if the MLD does not support the unavailability schedule, than none of the STAs support the unavailability schedule.

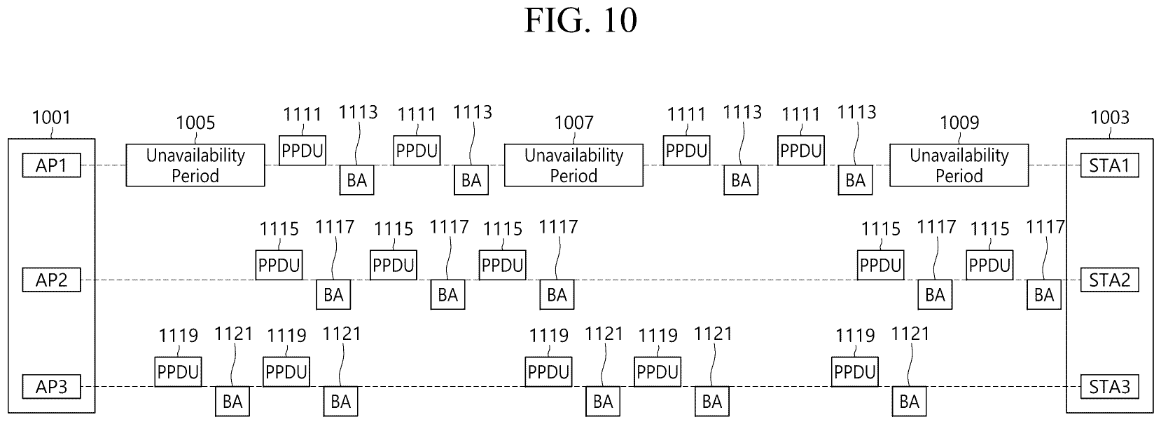

FIG. 10 illustrates an unavailability schedule operation with MLO in accordance with an embodiment. As illustrated, an AP MLD 1001 is affiliated with AP1, AP2 and AP3 and non-AP MLD 1003 is affiliated with STA1, STA2, and STA3. As illustrated, AP1 is associated with STA1 and is communicating with STA1 on a first link, AP2 is associated with STA2 and is communicating with STA2 on a second link, and AP3 is associated with STA3 and is communicating with STA3 on a third link. AP1 has several unavailability periods on the first link, including unavailability period 1005, 1007 and 1009. Between these unavailability periods, AP1 can communicate with STA2. In particular, AP1 transmits various PPDUs 1111 to STA1 and STA1 transmits various BAs 1113 to AP1.

The communication between AP2 and STA2 does not include any unavailability periods. In particular, as illustrated, the communication between AP2 and STA2 includes transmissions of various PPDUs 1115 from AP2 to STA2 and transmissions of various BAs 1117 from STA2 to AP2.

The communication between AP3 and STA3 also does not include any unavailability periods. In particular, as illustrated, the communication between AP3 and STA3 includes transmissions of various PPDUs 1119 from AP3 to STA3 and transmission of various BAs 1121 from STA3 to AP3.

In some embodiments, in multi-link operation, an AP's unavailability schedule support may be a STA-level capability. In some embodiments, in multi-link operation, an AP's unavailability schedule support may be a MLD-level capability.

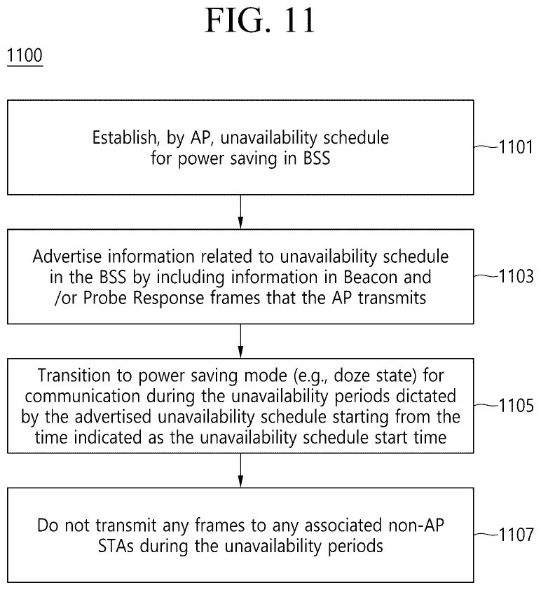

FIG. 11 illustrates a flow chart of an example process by an AP for the AP's unavailability schedule operation in accordance with an embodiment. Although one or more operations are described or shown in particular sequential order, in other embodiments the operations may be rearranged in a different order, which may include performance of multiple operations in at least partially overlapping time periods. The process 1100 begins in operation 1101.

In operations 1101, the AP establishes an unavailability schedule for power saving in its basic service set (BSS).

In operation 1103, the AP advertises information related to the unavailability schedule in its BSS. In some embodiments, the AP may advertise its unavailability schedule for power saving by including information in Beacon and/or Probe Response frames that the AP transmits.

In operation 1105, the AP transitions to a power saving mode and becomes unavailable for communication during the unavailability periods dictated by the advertised unavailability schedules starting from the time indicated as the unavailability schedule start time. In some embodiments, the AP may transition to a doze state during the unavailability period indicated in the power saving schedule.

In operation 1107, the AP does not transmit any frames to any associated non-AP STAs during the unavailability periods.

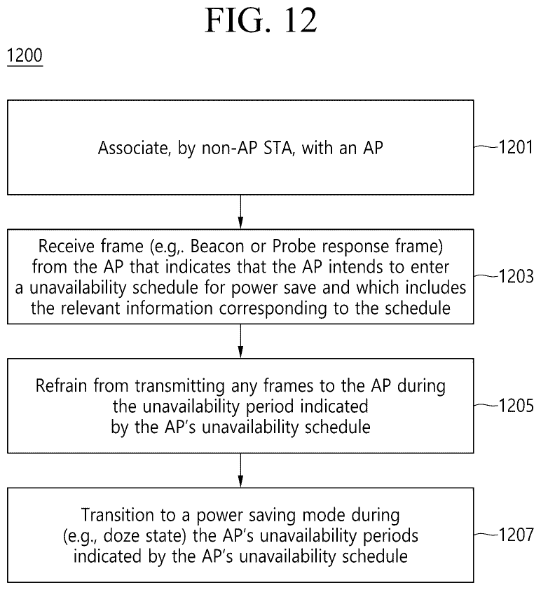

FIG. 12 illustrates a flow chart of an example process by an STA for an AP's unavailability schedule operation in accordance with an embodiment. Although one or more operations are described or shown in particular sequential order, in other embodiments the operations may be rearranged in a different order, which may include performance of multiple operations in at least partially overlapping time periods. The process 1200 begins in operation 1201.

In operation 1201, the non-AP STA associates with an AP.

In operation 1203, the non-AP STA receives a frame from the AP, where the frame indicates that the AP intends to enter an unavailability schedule for power saving and which includes the relevant information corresponding to the schedule. In some embodiments, the frame may be a Beacon frame or a Probe response frame that includes the AP's unavailability schedule.

In operation 1205, the non-AP STA refrains from transmitting any frames to the AP during the unavailability periods indicated by the AP's unavailability schedule.

In operation 1207, the non-AP STA transitions to a power saving mode during the AP's unavailability periods indicated by the AP's unavailability schedule. In some embodiments, the STA may transition to a doze state during the unavailability periods indicated by the schedule.

Embodiments in accordance with this disclosure may allow an AP to establish a unavailability schedule for power saving in its BSS, which can reduce the energy-consumption footprint of the wireless network. Furthermore, for a battery powered AP, the battery life may be improved by using an unavailability schedule for power saving.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) in a wireless network, comprising:
a memory; and
a processor coupled to the memory, the processor configured to:
establish a power saving schedule in a basic service set (BSS), wherein the power saving schedule includes one or more unavailable periods during which the AP is not available for frame exchange;
transmit, to one or more stations (STAs), a first frame that includes power saving schedule information;
exchange, with the one or more STAs, one or more frames during a period that does not belong to the power saving schedule; and
transition to a power saving mode during the one or more unavailable periods based on the power saving schedule.

2. The AP of claim 1, wherein the AP abstains from transmitting to or receiving any frames from the one or more STAs during the one or more unavailable periods.

3. The AP of claim 1, wherein the power saving schedule information includes a first time indicating when an unavailable period starts and a second time indicating a duration of the unavailable period.

4. The AP of claim 1, wherein:
the first frame is a beacon frame; and
the power saving schedule information includes a beacon counter indicating after which target beacon transmission time (TBTT) the power saving schedule takes effect or is suspended.

5. The AP of claim 1, wherein the power saving schedule information includes information indicating an unavailable period interval that represents a time between a first start time of a first unavailable period and a second start time of a second unavailable period.

6. The AP of claim 1, wherein the first frame is an individually addressed frame that is transmitted to each of the one or more STAs.

7. The AP of claim 1, wherein the processor is further configured to transmit, to the one or more STAs, a second frame indicating whether the AP supports the power saving schedule.

8. A station (STA) in a wireless network, comprising:
a memory; and
a processor coupled to the memory, the processor configured to:
receive, from an access point (AP), a first frame that includes power saving schedule information, wherein the power saving schedule includes one or more unavailable periods during which the AP is not available for frame exchange;
exchange, with the AP, one or more frames during a period that does not belong to the power saving schedule; and
transition to a power saving mode during the one or more unavailable periods based on the power saving schedule.

9. The STA of claim 8, wherein the STA abstains from transmitting to or receiving any frames from the AP during the one or more unavailable periods.

10. The STA of claim 8, wherein the power saving schedule information includes a first time indicating when an unavailable period starts and a second time indicating a duration of the unavailable period.

11. The STA of claim 8, wherein:
the first frame is a beacon frame; and
the power saving schedule information includes a beacon counter indicating after which target beacon transmission time (TBTT) the power saving schedule takes effect or is suspended.

12. The STA of claim 8, wherein the power saving schedule information includes information indicating an unavailable period interval that represents a time between a first start time of a first unavailable period and a second start time of a second unavailable period.

13. The STA of claim 8, wherein the first frame is an individually addressed frame that is received by the STA.

14. The STA of claim 8, wherein the processor is further configured to receive, from the AP, a second frame indicating whether the AP supports the power saving schedule.

15. A computer-implemented method for communication, by an access point (AP), in a wireless network, comprising:
establishing a power saving schedule in a basic service set (BSS), wherein the power saving schedule includes one or more unavailable periods during which the AP is not available for frame exchange;
transmitting, to one or more stations STAs, a first frame that includes power saving schedule information;
exchanging, with the one or more STAs, one or more frames during a period that does not belong to the power saving schedule; and
transitioning to a power saving mode during the one or more unavailable periods based on the power saving schedule.

16. The computer-implemented method of claim 15, wherein the AP abstains from transmitting to or receiving any frames from the one or more STAs during the one or more unavailable periods.

17. The computer-implemented method of claim 15, wherein the power saving schedule information includes a first time indicating when an unavailable period starts and a second time indicating a duration of the unavailable period.

18. The A computer-implemented method of claim 15, wherein:
the first frame is a beacon frame; and
the power saving schedule information includes a beacon counter indicating after which target beacon transmission time (TBTT) the power saving schedule takes effect or is suspended.

19. The computer-implemented method of claim 15, wherein the power saving schedule information includes information indicating an unavailable period interval that specifies a time between a first start time of a first unavailable period and a second start time of a second unavailable period.

20. The computer-implemented method of claim 15, wherein the first frame is an individually addressed frame that is transmitted to each of the one or more STAs.
